(19) United States
(12) Patent Application Publication
(10) Pub. No.: US 2025/0387804 A1
(43) Pub. Date: Dec. 25, 2025

(54) PLANT FOR CLASSIFICATION AND SELECTION OF OBJECTS COMPRISING PRECIOUS METALS AND OPERATION METHOD THEREOF

(71) Applicant: NEURAVISION S.R.L., Matera (IT)

(72) Inventors: Francesco Carlo Alberto Lence, Matera (IT); Angelo Raffaele Sacco, Matera (IT); Cosimo Rubino, Matera (IT)

(73) Assignee: NEURAVISION S.R.L., Matera (IT)

(21) Appl. No.: 18/875,478

(22) PCT Filed: Jun. 22, 2023
(86) PCT No.: PCT/EP2023/067018

§ 371 Date: Dec. 16, 2024

(30) Foreign Application Priority Data
Jun. 24, 2022 (IT) 102022000013372

(51) Int. Cl. B07C 5/342

(52) U.S. Cl. CPC B07C 5/342

(57) ABSTRACT

The present invention relates to a plant (I) for classification and selection of objects (O) comprising precious metals and copper, comprising a supporting frame (1) for supporting said plant (I) on the ground, which extends from a first end (11) to a second end (12), a conveyor belt (13), coupled to said support frame (1) capable of sliding according to a sliding direction (V) from said first end (11) toward said second end (12) in order to convey said objects (O), an image acquisition and processing device (2), arranged on said supporting frame (1) in said first end (11), raised with respect to said conveyor belt (13) and capable of acquiring the images of said objects (O), detecting predetermined visual features of said objects (O) in said acquired images, associating a category of precious metals comprised in said objects (O) with said visual features, classifying said objects (O) based on said association; sending signals corresponding to said classification; comprising at least one actuator device (3) arranged on said supporting frame (1) downstream of said image acquisition and processing device (2), capable of receiving said corresponding signals from said image acquisition and processing device (2) and of sorting said objects (O) based on said corresponding signals. The present invention also relates an operation method of said plant (I).

The present invention relates to a plant for classification and selection of objects comprising precious metals and copper, in particular waste electronic boards and used vehicle catalysts.

The present invention also relates to an operation method of said plant.

### TECHNICAL FIELD

More in detail, the invention relates to a plant of said type, designed and made in particular for the recognition and selection of objects comprising precious metals and copper, such as electronic boards and catalysts, aimed at recovery and recycling of the precious metals and copper therein contained, but which may also be used for any object containing precious metals and copper which may be recovered.

Hereinafter the description will be directed to a plant for classification and selection of electronic boards and catalysts, but it is well clear that the same shall not be considered as limited to this specific use.

### BACKGROUND ART

As it is well known currently, the selection of waste electronic boards is carried out manually by specialized personnel, trained to group the different types of electronic boards by visual inspection.

The selection has the purpose of obtaining portions of electronic boards that are homogeneous in terms of quantity of precious metals and copper therein contained, to be subsequently destined for recovery and refining.

The manual selection of the electronic boards involves the use of a large number of specialized workers, generally exposed to alienating work, in unhealthy work environments with a high risk of accidents and requires a large amount of time since the types of materials to be selected are numerous.

Moreover, the margin of error in the selection is determined by the degree of experience of each operator and by his level of concentration.

Systems used for selecting electronic waste, such as optical, color or shape recognition technologies, are also known.

Some of these known systems provide for the use of artificial intelligence algorithms which however only allow the separation of the electronic boards from other types of waste which are found inside the recovery plants.

As for the vehicle exhausted catalysts, to date there are no automatic selection systems, therefore, to date the sorting takes place exclusively manually, forcing the operators to compare each single identification number of the exhausted catalysts with some databases, which indicate the value thereof.

### OBJECT OF THE INVENTION

Therefore, in light of the above, the object of the present invention is to overcome the limits left unsolved by the prior art by providing a plant for classification and selection of objects comprising precious metals and copper, capable of automatically classifying the objects and of automatically selecting them based on the precious metals therein contained.

A further object of the present invention is to provide the tools necessary for carrying out the method and the apparatuses that carry out said method.

### DISCLOSURE OF THE INVENTION

Therefore, a specific object of the present invention is a plant for classification and selection of objects comprising precious metals and copper, comprising a support frame for supporting said plant on the ground, which extends from a first end to a second end, a conveyor belt coupled to said support frame and capable of sliding according to a sliding direction from said first end toward said second end in order to convey said objects, said plant comprising an image acquisition and processing device arranged on said support frame in said first end, raised with respect to said conveyor belt, capable of acquiring the images of said objects, detecting predetermined visual features of said objects in said acquired images, associating a category of precious metals comprised in said objects with said visual features, classifying said objects based on said association; sending signals corresponding to said association; and comprising at least one actuator device arranged on said support frame downstream of said image acquisition and processing device, capable of receiving said signals corresponding to said image acquisition and processing device and sorting said objects based on said corresponding signals.

Further according to the invention, said image acquisition and processing device comprises a control logic unit capable of supporting a neural network capable of detecting predetermined visual features of said objects in said acquired images, associating a category of precious metals comprised in said objects with said predetermined visual features, classifying said objects (O) based on said association.

Still according to the invention, said image acquisition and processing device comprises at least one lighting element capable of lighting up said objects, at least one detection element capable of acquiring images of said objects, a control logic unit operatively connected to said at least one lighting element and to said at least one detection element.

According to the invention, said at least one lighting element is a LED-Light Emitting Diode, and said detection element is a video camera or a CMOS optical sensor.

Preferably according to the invention, said image acquisition and processing device comprises a graphic interface, capable of showing the operator the result of the classification of said objects and of modifying the classification parameters.

Further according to the invention, said plant may comprise a plurality of slides arranged in said second end of said conveyor belt, said actuator device comprising at least one piston capable of moving from a rest position that is retracted with respect to said conveyor belt, to an extracted work position, in which it is capable of contacting said objects arranged on said conveyor belt and of conveying them toward a slide of said plurality of slides based on said corresponding signals.

Still according to the invention, said plant may comprise a plurality of slides arranged in said second end of said conveyor belt, and said actuator device comprising a support element, coupled to said support frame, raised with respect to said conveyor belt, and a gripping and conveying means, coupled to said support element, capable of picking up said objects arranged on said conveyor belt and of conveying them toward a slide of said plurality of slides based on said corresponding signals.

A further object of the present invention is an operation method of a plant, comprising the following steps:
acquiring the images of said objects by means of said image acquisition and processing device;
detecting predetermined visual features of said objects in said acquired images by means of said control logic unit;
associating a category of precious metals present in said objects with said predetermined visual features;
classifying said objects based on said association and sending signals corresponding to said classification;
sorting said objects based on said corresponding signals by means of said actuator device.

Further according to the invention, said detection step comprises the following sub-steps:
conditioning the image acquired in said acquisition step;
extracting the predetermined visual features by means of trained convolutional filters;
classifying the objects by means of a neural network.

Still according to the invention, said method comprises the step of training said neural network, comprising the following sub-steps:
determining the images dataset for training the neural network;
selecting the images based on their quality;
associating each image selected in said selection step with a determined category based on the precious metals and copper comprised in the object (O) of the image.

### BRIEF DESCRIPTION OF THE DRAWINGS

The present invention will now be described by way of non-limiting example according to the preferred embodiments thereof, particularly referring to the figures of the appended drawings, in which:

FIG. 1 shows an isometric view of the plant for classification and selection of objects comprising precious metals and copper, object of the present invention, according to a first embodiment;

FIG. 2 shows a top view of a component of the plant shown in FIG. 1;

FIG. 3 shows a block diagram of the operation method of the plant shown in FIG. 1;

FIG. 4 shows a block diagram of a part of the operation method of the plant shown in FIG. 1;

FIG. 5 shows an isometric view of the plant for classification and selection of objects comprising precious metals and copper, object of the present invention, according to a second embodiment.

### DETAILED DESCRIPTION

In the various figures similar parts will be indicated with the same reference numbers.

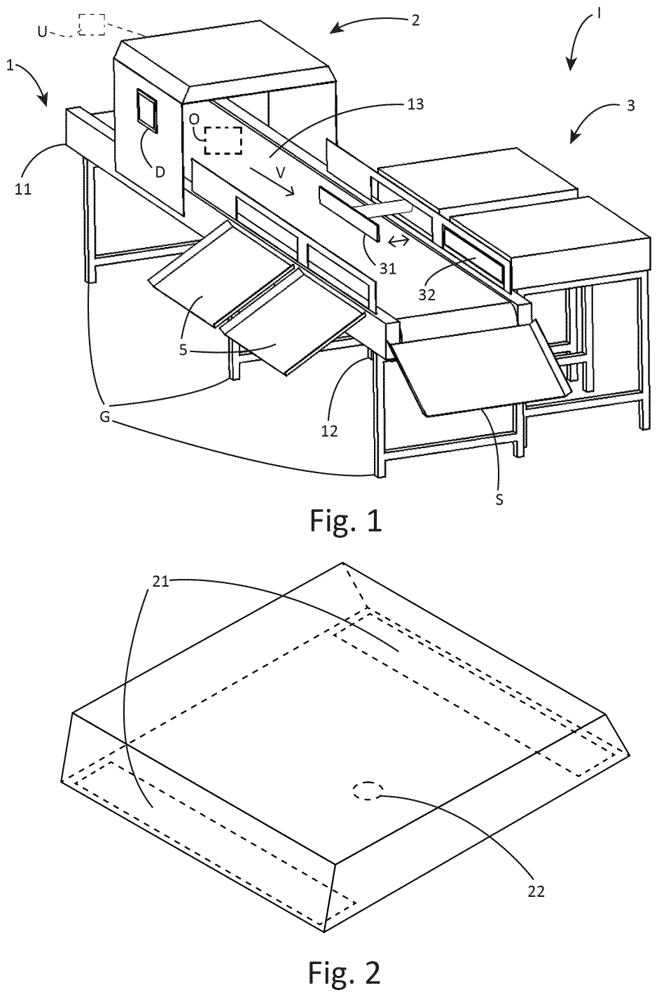

Referring to FIG. 1, the plant I for classification and selection of objects O comprising precious metals and copper, basically comprises a supporting frame 1 for supporting said plant I on the ground, an image acquisition and processing device 2 arranged on said supporting frame 1, an actuator device 3 arranged on said supporting frame 1 downstream of said image acquisition and processing device 2.

Said supporting frame 1 extends from a first end 11 to a second end 12.

Said supporting frame 1 comprises a plurality of support legs G.

Said supporting frame 1 comprises a plurality of outputs or slides S, arranged downstream of said image acquisition and processing device 2.

Said sorted objects O are conveyed through said slides S from said plant I toward collection containers, not shown in the figure and not being object of the present invention.

Said plant I comprises a conveyor belt 13, coupled to said supporting frame 1, capable of sliding according to a sliding direction V from said first end 11 toward said second end 12, in order to convey said objects O in said plant I.

Said objects O are waste electronic boards comprising precious metals such as gold, silver, palladium, rhodium and the like and a non-precious metal as well, such as copper.

Said objects O are catalysts as well, which also comprise precious metals, mainly palladium, rhodium, and platinum.

Without departing from the scope of protection of the present invention, said objects O may also be other known objects, comprising precious metals and copper.

Said plant I comprises an image acquisition and processing device 2 coupled to said supporting frame 1.

In particular, said image acquisition and processing device 2 is arranged in said first end 11 and is raised with respect to said conveyor belt 13.

Said image acquisition and processing device 2 is capable of detecting the precious metals and copper contained in said objects O, of classifying said objects O based on said detection and of sending signals corresponding to said classification.

In particular, said image acquisition and processing device 2 is capable of detecting the images of said objects O.

Still more in particular, referring to FIG. 2, said image acquisition and processing device 2 comprises at least one lighting element 21 and at least one detection element 22.

Said at least one lighting element 21 is of the LED type—Light Emitting Diode—or the like.

In this embodiment, said image acquisition and processing device 2 comprises two lighting elements, but it is also possible to provide for different numbers thereof.

Said at least one detection element 22 is a video camera or an optical sensor of the CMOS type.

Said at least one detection element 22 is arranged at a predetermined distance from said conveyor belt 13, so as to be capable of detecting images of said objects O from different angles.

Said image acquisition and processing device 2 comprises an optical sensor or photoelectric diode, not shown in the figure, capable of detecting the presence of the objects O on the conveyor belt 13, at said image acquisition and processing device 2 and activates said lighting element 21 and video camera 22 to acquire the image.

Said image acquisition and processing device 2 comprises a control logic unit U that is operatively connected to said video camera and to said lighting element.

Said logic control unit U is provided with a memory unit, in which data and operating parameters of said plant I and also said images detected by said video camera are stored.

Said logic control unit U is capable of processing said images, as it will be described in detail hereinafter.

Moreover, said logic control unit U is capable of sending signals corresponding to said image processing.

In particular, in said memory, unit categories of said objects O are stored based on the quantity and type of precious metals and copper therein present.

In this invention in particular five categories of precious metals present in said objects O are predetermined, which copper is added to.

Associations between the images of said objects O and the categories of precious metals and copper therein contained are then predefined and stored in said memory unit.

Said associations are obtained by means of experimental tests.

In the present invention, the association mode between images of objects O and categories of precious metals and copper is structured by means of a look-up table.

However, without departing from the scope of protection of the present invention, said association modes may be different.

Moreover, said logic control unit U comprises a processing unit which is capable of implementing a neural network.

Without departing from the scope of protection of the present invention, said neural network may also be contained in remote devices, such as a cloud.

Said neural network is trained with the associations of the images of the objects O and of the categories based on the precious metals and copper present in said objects O.

In use, as it will be described in detail hereinafter, said neural network is capable of recognizing the image of an object O and of associating the category based on the precious metals and copper present in said objects O.

Said image acquisition and processing device 2 further comprises a graphic interface or display D, operatively connected to said logic control unit U.

The operator may interact with said plant I by means of said display D.

For instance, the operator may display the classification result of the objects O.

Moreover, the operator may modify the classification levels of the objects O by means of said display.

In particular, the operator may decide which categories of objects O to select or combine.

Said actuator device 3 is arranged on said supporting frame 1, downstream of said image acquisition and processing device 2, substantially in said second end 12.

Said actuator device 3 receives said signals sent by said logic control unit U by means of a PLC unit—programmable logic controller, or wirelessly or via Bluetooth®.

In a first embodiment, said actuator device 3 comprises at least one piston 31.

Said actuator device 3 is capable of receiving said signals sent by said logic control unit U, by means of said PLC unit and of controlling said piston 31, so as to sort said objects O in order to convey them toward a slide of said plurality of slides S.

Said actuator device 3 may also comprise further pistons in order to optimize the sorting.

In the described embodiment, said plant I comprises a second piston 32.

Said piston 31 is capable of moving from a rest position that is retracted with respect to said conveyor belt 13, to an extracted working position, in which it is capable of contacting said objects O arranged on said conveyor belt 13 in order to convey them toward a slide of said plurality of slides S.

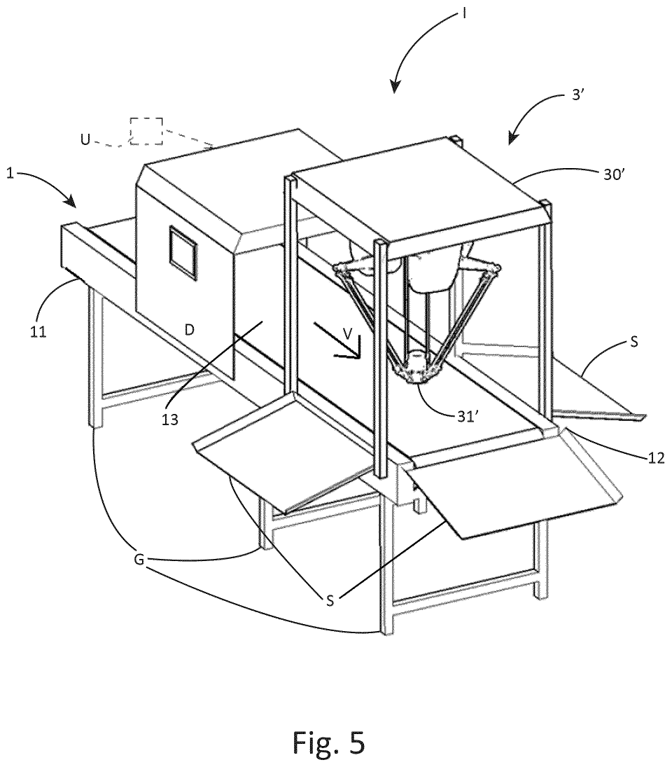

Referring to FIG. 5, in a second embodiment, said plant I differs from the one above described just in the structure of the actuator device 3′.

Said actuator device 3′ comprises a supporting element 30′, coupled to said supporting frame 1, raised with respect to said conveyor belt 13 and a gripping and conveying means 31′, coupled to said supporting element 30′.

Said actuator device 3′ is capable of receiving said signals sent by said logic control unit U, by means of said PLC unit, and of controlling said gripping and conveying means 31′, so as to sort said objects O in order to convey them toward a slide of said plurality of slides S.

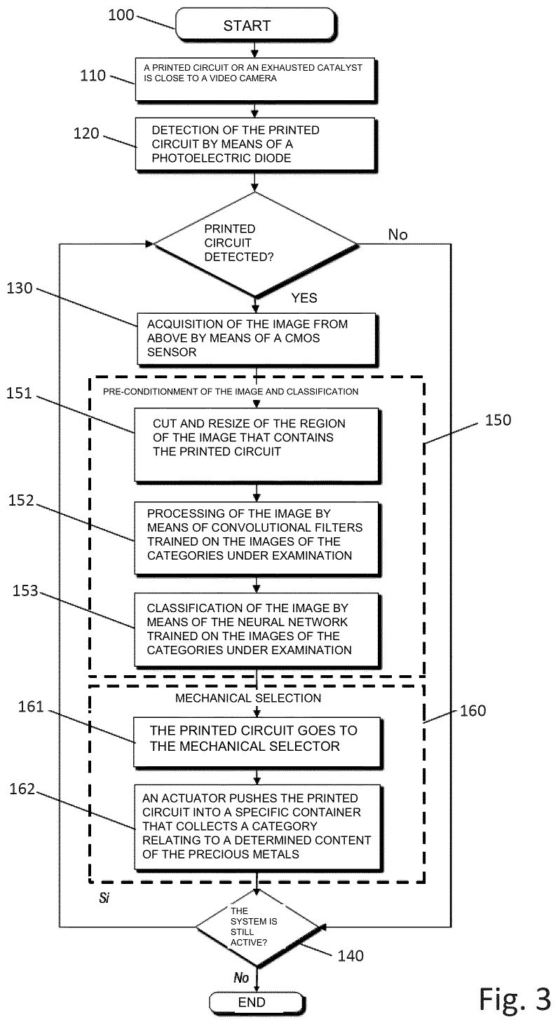

The operation of the above described plant I for classification and selection of objects O comprising precious metals and copper takes place as follows, referring to the block diagram shown in FIG. 3.

In an initial step 100, said plant I is activated.

In a positioning step 110, an object O is positioned onto said conveyor belt 13 that slides according to said sliding direction V until it gets into said image acquisition and processing device 2.

In a presence verification step 120, said diode verifies the presence of the object O on the conveyor belt 13.

If the object O is detected, an acquisition step 130 is performed, in which the image of the object O is acquired by means of said video camera 22.

Instead, if the object O is not detected, an operation verification step 140 of the plant I is performed.

If the plant I is switched on, the verification step 120 of the presence of the object O is performed again, if the plant I is switched off, the method ends.

Further to said acquisition step 130, a set of pre-conditioning and treatment step 150 of the detected images is performed.

In particular, in a first step 151, the acquired image of the object O is cut and resized, so as to maximize the identification of the object O in the image.

In a second step 152, the image cut and resized in the first step 151 is processed by means of trained convolutional filters, in order to extract the visual features thereof necessary for the classification.

Said visual features are extracted automatically by the convolutional network based on the input dataset.

In a third step 153, the neural network classifies the images coming from the processing of the previous steps, based on the criteria acquired during the training.

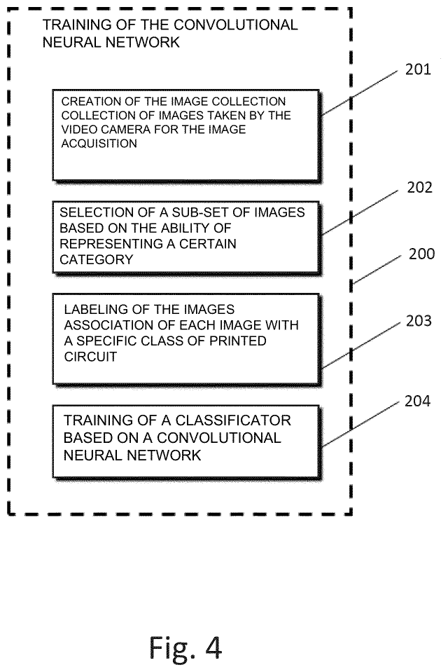

In particular, referring to FIG. 4, the training step 200 takes place by means of the following sub-steps.

In a first sub-step 201, the image dataset for training the neural network is determined, which is stored in said memory unit of said control logic unit U.

In a second sub-step 202, the quality of the data sub-sets is selected, namely the images are selected based on their quality, in particular on the ability to faithfully represent the category they belong to.

In a third sub-step 204, each detected image is associated with a determined category, based on the precious metals and copper comprised in the object O of the image, according to predetermined lab data.

In a fourth sub-step 205, the neural network is trained to the classification.

After having performed the third classification step 153, mechanical selection steps 160 are performed.

In particular, in a first sub-step 161, the object O is conveyed by said conveyor belt 13 toward said second end 12.

In a second sub-step 162, said pistons 31, 32 sort said objects O based on the classification.

In particular, said pistons 31, 32 convey the object O toward the slide associated with the classification of the object O.

Indeed, a category is associated with each slide of said plurality of slides S based on the precious metals and copper present in the object O.

The operator may set up in which slide to convey the types of objects O according to own needs.

### Advantages

As it is clear from the above reported description, the plant object of the present invention allows separating the electronic boards and the catalysts based on the content of precious metals and copper present therein, thus significantly reducing the margin of error associated with the recognition thanks to artificial intelligence algorithms.

In this way, the health risks associated with the prolonged handling of waste materials by operators and with the repetitiveness of the selection operation are eliminated or at least reduced.

Moreover, unlike an operator who requires a coaching phase for training in recognizing the cards based on their appearance, associated with the metal content, the plant does not need an initial period to be fully operational.

The present invention has been described by way of non-limiting example according to the preferred embodiments thereof, but it should be clear that variations and/or changes can be made by the persons skilled in the art without departing from the related scope of protection, as defined by the appended claims.

1. A plant for classification and selection of objects comprising precious metals and copper, comprising
a supporting frame for supporting said plant on the ground, which extends from a first end to a second end,
a conveyor belt, coupled to said supporting frame, capable of sliding according to a sliding direction from said first end to said second end in order to convey said objects, wherein said plant comprises an image acquisition and processing device arranged on said supporting frame in said first end, raised with respect to said conveyor belt, capable of acquiring the images of said objects, detecting predetermined visual features of said objects in said acquired images, associating a category of precious metals comprised in said objects with said visual features, classifying said objects based on said association, and sending signals corresponding to said classification; and
wherein said plant comprises at least one actuator device arranged on said supporting frame downstream of said image acquisition and processing device, capable of receiving said corresponding signals from said image acquisition and processing device and of sorting said objects based on said corresponding signals.

2. The plant according to claim 1, wherein said image acquisition and processing device comprises a logic control unit capable of supporting a neural network capable of detecting predetermined visual features of said objects in said acquired images, associating a category of precious metals comprised in said objects with said predetermined visual features, and classifying said objects based on said association.

3. The plant according to claim 2, wherein said image acquisition and processing device comprises at least one lighting element capable of lighting up said objects;
at least one detection element capable of acquiring images of said objects;
a logic control unit, operatively connected to said at least one lighting element and to said at least one detection element.

4. The plant according to claim 3, wherein said at least one lighting element is a LED—Light Emitting Diode, and in that said detection element is a video camera or a CMOS optical sensor.

5. The plant according to claim 1, wherein said image acquisition and processing device comprises a graphic interface capable of showing the operator the result of the classification of said objects and of modifying the classification parameters.

6. The plant according to claim 1, wherein it comprises a plurality of slides arranged in said second end of said conveyor belt, and in that said actuator device comprises at least one piston capable of moving from a rest position, retracted with respect to said conveyor belt, to an extracted working position, in which it is capable of contacting said objects arranged on said conveyor belt and of conveying them toward a slide of said plurality of slides based on said corresponding signals.

7. The plant according to claim 1, wherein it comprises a plurality of slides arranged in said second end of said conveyor belt, and in that said actuator device comprises a supporting element coupled to said supporting frame, raised with respect to said conveyor belt, and a gripping and conveying means coupled to said supporting element, capable of picking up said objects arranged on said conveyor belt and of conveying them toward a slide of said plurality of slides based on said corresponding signals.

8. An operation method of a plant, comprising the following steps:
acquiring images of objects by means of an image acquisition and processing device;
detecting predetermined visual features of said objects in said acquired images by means of a logic control unit;
associating a category of precious metals comprised in said objects with said predetermined visual features;
classifying said objects based on said association and sending signals corresponding to said classification;
sorting said objects by means of an actuator device based on said corresponding signals.

9. The method according to claim 8, wherein said detection step comprises the following sub-steps:
conditioning the image acquired in said acquisition step;
extracting the predetermined visual features by means of trained convolutional filters;
classifying said objects by means of a neural network.

10. The method according to claim 9, wherein it comprises the step of training said neural network, comprising the following sub-steps:
determining the image dataset for training the neural network;
selecting the images based on their quality;
associating each image selected in said selection step with a certain category based on the precious metals and copper comprised in the object of the image.
